(19) United States
(12) Patent Application Publication
(10) Pub. No.: US 2023/0026193 A1
(43) Pub. Date: Jan. 26, 2023

(54) Automatic Bobbin Control

(71) Applicant: LENZING AKTIENGESELLSCHAFT, 4860 Lenzing (AT)

(72) Inventors: Josef Baumgartinger, 4841 Timelkam (AT); Christoph Ramsauer, 5360 St. Wolfgang (AT); Dominik Ostaszewski, 4690 Rüstof (AT); Andreas Schlader, 4840 Vöcklabruck (AT); Christoph Schrempf, 4701 Bad Schallerbach (AT)

(21) Appl. No.: 17/791,087

(22) PCT Filed: Jan. 7, 2021
(86) PCT No.: PCT/EP2021/050153

§ 371 Date: Jul. 6, 2022

(30) Foreign Application Priority Data
Jan. 7, 2020 (EP) 20150447.9

(51) Int. Cl. B65H 63/00; G01B 11/25; G06T 7/00

(52) U.S. Cl. CPC B65H 63/006; G01B 11/25; G06T 7/0004; B65H 2701/31; G06T 2207/10152; G06T 2207/30124; G06T 2207/20081

(57) ABSTRACT

The present invention relates to a method for quality control of bobbins.

### BACKGROUND OF THE INVENTION

Monofilaments and multifilament yarns, especially based on cellulose, are produced on a large scale and used in many fields, such as textile industry but also in technical fields. An example of such mono- and multifilaments are filament yarns produced by the lyocell process from a composition of cellulose in a solvent, usually a mixture of water and N-methylmorpholine-N-oxide (NMNO). After spinning and various post-treatments, both monofilaments and multifilaments are wound into bobbins on spools and then, before further use (such as packaging and shipping to customers), stored. Samples are typically taken from the filaments or yarns produced and various parameters are evaluated. However, quality control is also necessary for the filaments and yarns wound onto the spools.

Due to the high production speeds, several thousand such bobbins may be produced per day in a Lyocell plant, which then have to be fed to the post-control of desired properties. Thus, on the one hand, quality characteristics of the bobbins are quantified and are then available for characterization of the bobbins (i.e. basically the filament yarns wound on the bobbins). At the same time, a timely evaluation also allows feedback to the production process, since visible filament yarn defects can be reported back to the production department, so that interventions can be made in the production process if necessary.

Currently, such bobbin inspections are mainly carried out manually, i.e. specially trained personnel visually inspect the individual bobbins for defects. This is a highly specialized task, since a surface has to be inspected and evaluated in as short a time as possible with regard to a large number of possible faults and defects. This has several disadvantages. For example, despite good training, there is bound to be variability in the evaluation during such inspections, and there is always the possibility that errors and defects will be overlooked. Also, manual handling during evaluation can create errors or defects on the bobbins. At the same time, timely evaluation of a high number of bobbins is often not possible, especially in the continuously operated production lines. Thus, there is either a time lag between production and evaluation (which, for example, makes timely necessary feedback to production control impossible), or not all bobbins are evaluated (only a certain number of bobbins are tested, which, according to experience with the respective production plant, provide statistically meaningful data). This is no longer justifiable, especially due to the ever-increasing requirements for documentation, also vis-à-vis purchasers. In the meantime, a complete evaluation and documentation of the evaluation results is required. This is also advantageous with regard to the possibilities of own objective defect recording for production plants.

However, there are already approaches to no longer inspect certain types of defects by human inspection. DE 20 2006 002 317 U1, for example, discloses a method for inspecting filament bobbins. In this process, a laser scanner is used to detect, in particular, filament breaks and other filament defects. What is disclosed in this document is that a laser scanner is to be used alone, since otherwise the inspection device becomes too costly and takes up too much space. DE 41 24 750 A1 discloses a device for detecting a winding defect. This document is also aimed at detecting yarn breaks or similar filament faults, but here a light beam is used to scan the end face of a bobbin so as to detect faults in the yarn feed over the end face of the bobbin. DE 10 2005 001 223 A1 discloses a device for detecting the orientation of spinning buds, for example, in order to be able to separate such spinning buds in a targeted manner. JP H06 72634 A and JP S63 272753 A disclose optical cameras. Insofar as this prior art relates to the inspection of filament bobbins, these focus on filament breaks and similar filament defects, each of which is detected by a single type of inspection. DE 20 2006 002 317 U1 explicitly notes the advantage of using only one type of inspection in this context. This state of the art is therefore not able to replace the human inspection of filaments wound on spools (bobbins), since in particular it does not succeed in detecting a large number of defect types.

It is therefore the underlying task of the present invention to overcome these disadvantages from the prior art.

### BRIEF DESCRIPTION OF THE FIGURES

FIGS. 1 to 3 show typical types of defects that can be detected by the system and method according to the invention.

FIG. 1 shows the defect type capillary breakage.

FIG. 2 shows the error type contamination

FIG. 3 shows the error type bobbin damage

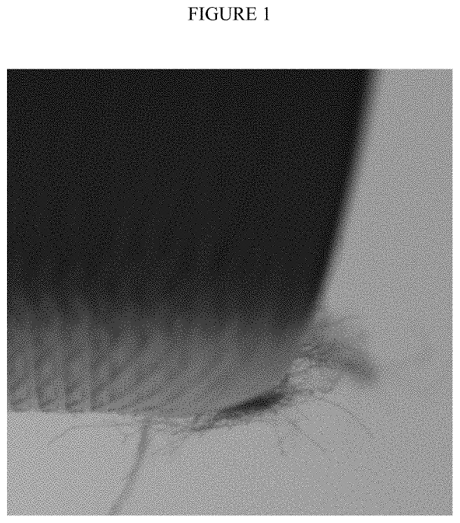

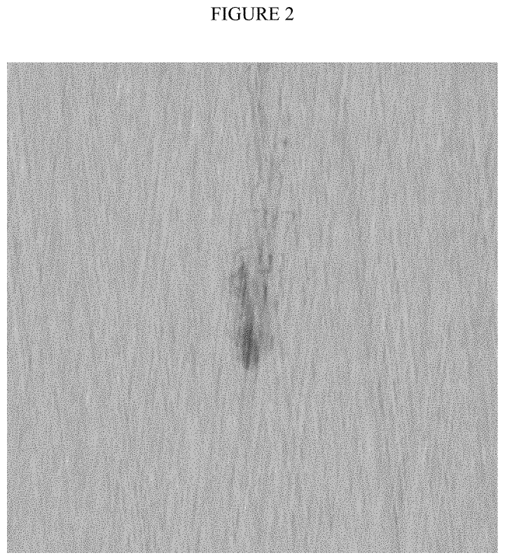

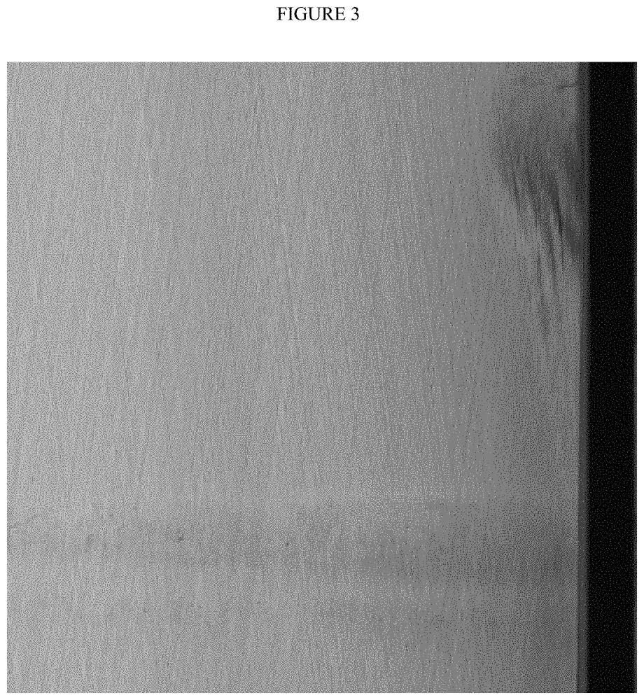

### SUMMARY OF THE INVENTION

The present invention therefore provides a method according to claim 1. Preferred embodiments are given in the subclaims as well as in the following description.

### DETAILED DESCRIPTION OF THE INVENTION

The present invention provides a method for quality control of bobbins (i.e., monofilaments or multifilaments of so-called filament yarns wound on tubes), in which the surfaces of the bobbins are detected with optical systems and the data thus obtained are automatically compared with specified parameter limits and the quality of the bobbins is thus determined. Surface in the sense of the present invention are both the face and foot surfaces of the bobbins as well as the shell surface. The inspection of the face and foot surfaces serves in particular to reliably detect defects of the bobbin core.

It is preferred if the detection of the surface is carried out in such a way that the respective bobbin to be inspected rotates about its longitudinal axis during the detection. In this way, static optical systems can easily and reliably detect the entire surface of the coil. Systems that enable such a rotational movement of the coil are known. At the same time, it is preferred if the insertion of the coils directly into such systems or into an upstream loading system, such as a turret/carousel/continuous transport system, etc., is also performed automatically. This simplifies the testing of large numbers of bobbins and also avoids errors due to manual handling. Furthermore, such a process control not only allows a contactless evaluation per se, but also standardizes all touching of the bobbin when inserting it into the system, as well as when removing it from the system.

The optical detection of the bobbin surface and the comparison with defined standard values allows a fast and qualitatively always constant evaluation of the bobbin quality. Here it has been surprisingly found that despite the complex task (which in the current process flow, as explained above, requires specially trained personnel), the automated control and comparison with specified parameters by a suitable system of data evaluation, quickly and reliably allows an evaluation.

According to the invention, it has been shown that a combination of two different types of optical systems is necessary to enable a satisfactory evaluation. On the one hand, an optical system based on multidimensional laser scanners is necessary, which is suitable to detect coarse defects. These are manifested in particular by deviations of the bobbin from its normal configuration. These include in particular major damage, such as dents in the bobbin surface (shell surface), deviations from the desired bobbin geometry, such as saddle formation or lateral ring formation, as well as core defects, i.e. defects of the winding core that adversely affect the overall structure of the bobbin (which may conveniently be done by detecting and evaluating the face and foot surfaces). Particularly suitable for this purpose are systems that scan the surface of the bobbin and thus, due to the rotation of the bobbin, enable the generation of a profile of the bobbin shape. Laser scanning systems are suitable for this purpose, for example. The profile shape obtained can then be easily compared with the desired standard shape of the coil and any deviation evaluated accordingly.

On the other hand, an image-recording optical system (camera) is necessary that captures images, in particular of the shell surface, which then enable evaluation with respect to defects, such as contamination, fingerprints, fiber or capillary breaks, etc. If such systems are used together with light sources, the sensitivity can be further increased and additional parameters, such as color tone of the bobbin, can be detected. Light sources that emit light of specific wavelength (or specific wavelength ranges) and/or light patterns, such as pulsating illumination, variation of wavelengths, variation of light intensities, and high-frequency change of illumination are suitable here. In this way, as explained above, on the one hand the sensitivity (and thus the accuracy) of the evaluation can be improved, and on the other hand other parameters can be checked (for example, by matching them with standard color patterns or hues). Thus, images of the surface are taken and these are compared again (as a two-dimensional image) with a desired standard condition. In this way, smaller but also highly relevant defects and flaws that are more strongly linked to the filament yarns to be evaluated can be detected and quantified. These include in particular defects such as fingerprints, contamination with dust, hairs, insects, etc., as well as fluff, breaks, snags and likewise core defects. For this purpose, as already explained above, image-generating systems can be used, such as cameras.

In principle, it is therefore possible to carry out largely automated quality control of bobbins merely by using two optical systems. For this purpose, a bobbin is first loaded into the bobbin control system, preferably automatically, as indicated above, and then detected without contact by optical systems. The data obtained allows an evaluation of the quality of the bobbin (type and number of defects), which is either done manually after visualization of the measurement data by appropriate personnel or automatically by comparison with specified standard values. By using self-learning evaluation units, such a system can continuously increase the accuracy of the evaluation of bobbins during operation. Thereby, when using adaptive algorithms, an automatically acting classifier is obtained.

Of course, not only two but also a higher number of optical systems can be used to detect the bobbin surface. This can increase the accuracy of the evaluation because, for example, different camera systems have different sensitivities to different types of defects and flaws. By using different light sources to illuminate/illuminate the bobbin during optical detection, for example, deviations or variations in color tone can be detected. Different types of cameras can be used to obtain different types of images of the bobbin surface so that the process can be better adapted to different types of defects.

Due to the fact that the evaluation is carried out, in particular preferably by self-learning data evaluation systems, statistical evaluations and logging of the errors of the examined bobbins can be carried out and stored with great accuracy. This leads to the automated construction of a data library, which is also helpful for the further use of the filament yarns on the bobbins. At the same time, if the evaluation of the bobbins is carried out close in time to the production of the respective filament yarn, such a system can also contribute to automated production control. Thus, depending on the type of detected defects on/at the bobbins, corresponding error messages can be transmitted to the respective production facilities, which can then react quickly to such error messages. Thus, the system according to the invention not only contributes to the improvement of the quality control of the bobbins, but also contributes to the quality control of the entire production process.

By using the method of the invention, bobbins with monofilaments as well as bobbins with multifilaments can be evaluated. Also, bobbins of different sizes can be evaluated using the method, including very large bobbins where current manual inspection is problematic simply because of the dimensions and weight of the bobbin.

The advantages to be realized by the process according to the invention can be illustrated as follows:

1) The ability to automatically feed and discharge bobbins into and out of the control system allows large quantities of bobbins to be handled.

2) By using a device that allows the bobbins to be evaluated to rotate around the longitudinal axis (winder core), it is possible to permanently mount the optical system used for evaluation so that constant conditions prevail here during the evaluation.

3) By acquiring measurement data on rotating bobbins, two-dimensional profiles of the bobbin can be generated as such, so that coarser winding errors or bobbin defects, for example caused by defective winding cores, can be easily detected.

4) By combining two optical systems as described above, optionally in combination with light sources, the relevant faults and defects to be evaluated can be detected with sufficient certainty and reproducibility, so that the “human” factor and the inevitably associated sources of error (non-detection of faults) and fluctuations in the evaluation of detected faults can be excluded.

5) The system allows fully automatic evaluation of a large number of bobbins, so that there is neither a large time delay in the evaluation compared to the production process, nor is it necessary to forego the evaluation of individual bobbins.

6) In this way, fault warnings can be transmitted to production plant control virtually in real time.

7) Defect detection and evaluation can be objectified qualitatively and quantitatively, so that consistent data can be obtained here over long production periods.

8) By using self-learning systems for measurement data evaluation and classification, the evaluation of the bobbins can continue to evolve, making the system continuously more reliable and robust. The data obtained is suitable for providing an electronic library of the data, so that an optimized selection option is available, particularly with regard to the further use of the bobbins. For example, the system can automatically find very similar bobbins in terms of quality (for example, with regard to winding defects) easily (and then group them together for common further use, for example).

9) By increasing the number of optical systems used for evaluation, defect detection and defect evaluation can be further differentiated—different types of defects can be better detected and quantified, more data can be obtained with respect to product variation.

1. A method for quality control of a bobbin, wherein the bobbin is evaluated with at least two optical systems, one optical system comprising a laser scanner for acquiring data to generate a profile of the bobbin, and at least one other optical system comprising an optical camera for acquiring data to generate a two-dimensional image of a bobbin surface.

2. The method of claim 1, wherein the bobbin rotates about its longitudinal axis when measured by the at least two optical systems.

3. The method according to claim 1, wherein the data are compared by means of a data evaluation system with standard values for evaluating quality of the bobbin.

4. The method according to claim 1, wherein the bobbin is illuminated with light of specifically adjustable wavelength and different adjustable light patterns during data acquisition.

5. The method of claim 1, wherein the bobbin is automatically inserted into the at least two optical systems for quality control and automatically exported out of the at least two optical systems upon completion of measurement.

6. The method according to claim 1, wherein quality assessment obtained by evaluation, when certain limit conditions are exceeded, automatically transmits warning messages to production control.

7. The method of claim 1, wherein the bobbin is a filament bobbin, or a yarn bobbin.

8. The method of claim 1, wherein more than two optical systems are used.

9. The method of claim 1, wherein the at least two optical systems used to evaluate collected measurement data are self-learning systems.
